(19) United States
(12) Patent Application Publication
(10) Pub. No.: US 2005/0213994 A1
(43) Pub. Date: Sep. 29, 2005

(54) Arrayed receiver optical sub-assembly including layered ceramic substrate for alleviation of cross-talk and noise between channels

(76) Inventors: Michael Thomas Dudek, Longmont, CO (US); Allen Tracy, Eire, CO (US)

Correspondence Address: BARLOW, JOSEPHS & HOLMES, LTD., 101 DYER STREET, 5TH FLOOR, PROVIDENCE, RI, 02903, US

(21) Appl. No.: 10/812,197

(22) Filed: Mar. 29, 2004

(51) Int. Cl. H04B 10/06

(52) U.S. Cl. 398/202

(57) ABSTRACT

A receiver optical subassembly (ROSA) includes a photodetector array and a transimpedance amplifier (TIA) array. In each data channel, the photodetector is wire bonded to a corresponding input pad of the TIA array. A ground pad is disposed between adjacent input pads and connected to a ground plane via an isolated bonding strip on the photodetector array in order to alleviate crosstalk between the channels. The output data channels of the TIA are tightly spaced at the output pads of the TIA and are fanned out on the ceramic to increase the spacing of the data channels as they extend from the TIA. The ROSA includes the use of embedded capacitance to reduce crosstalk and noise by decoupling reference planes formed within the multilayer ceramic substrate. Input and output ground planes of the TIA are separated in the vicinity of the TIA and coupled on a ceramic layer spaced farther from the TIA, to alleviate crosstalk.

### BACKGROUND OF THE INVENTION

The instant invention relates, most generally, to receiver optical sub-assemblies (ROSA's). More particularly, the present invention is related to the alleviation of cross-talk between channels of an arrayed ROSA and the reduction of noise in the arrayed ROSA.

ROSA's (receiver optical sub-assemblies) re used in the optoelectronics industry to receive optical signals and convert the signals to electrical data signals. To maintain the advanced integration levels required in today's optoelectronics industry, ROSA's typically include both a tightly-packed array of optical receivers, as well as a similarly dimensions arrays transimpedance amplifier (TIA). These active, arrayed components are typically included, along with other passive components, in a very compact package. A tightly packaged array of parallel data channels such as this can introduce crosstalk and noise-induced degradation of the individual channel's data signal from several sources over different paths. In general, crosstalk may be introduced within the optical receiver array, at the input of the TIA array, within the TIA array, or beyond the output of the TIA array (within the package substrate itself).

Each optical receiver provides an electrical data signal in a data channel. The data channels are tightly spaced and include a small pitch. The pitch between data channels of an arrayed optical receiver may be 250 microns according to one industry standard. The pitch between data channels influences the pitch of the optical receiver array of the system. The optical receivers may be photodetectors, which provide a low-amplitude current output that may be amplified and converted to a voltage output by the TIA. A filter is typically provided to alleviate substrate cross-talk between photodetectors. The TIA array must be placed in close proximity to the photodetector array to avoid degradation of the data signal imposed by parasitics due to the length of the wire bond connection between each photodetector and the corresponding TIA input. The length of the wire bond connection is directly related to the magnitude of the inductance of the wire bond, and therefore directly related to the level of degradation of the electrical current signal to the TIA. An additional complication related to arrays is the mutual inductance of signal wire bonds that are in close proximity. Internal crosstalk between data channels at the input of the TIA may also present a significant problem. Typically, a connection to ground is provided between TIA input pads to act as a shield between input signals. However tight packing requirements and the close proximity of the detector array make it difficult to locate a ground plane close enough to connect the TIA input ground pads.

The output of each TIA must be coupled to a post-amplifier (PA) integrated circuit that is generally, but not necessarily placed on a printed circuit board (PCB), and not within the ROSA. For example, the ROSA may be mounted on the PCB, which includes the post amplifier integrated circuit. In high speed applications, the distance that separates the TIAs from the post-amplifier is significant. Furthermore, the TIA signal output power is low, relative to that of the post-amplifier. It is therefore imperative to maintain the integrity of the high-speed data signals by maintaining system-matched differential impedance and “electrically short” signal lines for the given speed. The channels, which may include high-speed data signals, are also closely spaced, and typically, use a differential pair configuration to protect against common mode noise from nearby parasitic sources that may degrade the integrity of the data signals. The high number of differential pair outputs packed in a small area are especially susceptible to inter-channel crosstalk and make it difficult to provide interconnects from the TIA output pads to the package substrate.

In an arrayed ROSA in which multiple high-speed channels are operating simultaneously in a small package, crosstalk may occur between channels and may be fed to the input of the various optoelectronic components. Crosstalk may come from many sources, including but not limited to the following sources. First, common-mode paths, such as reference planes, wherein inductive or capacitive parasitics can feed signal noise back from any point to the input stage of either the detectors or the TIA's for example. Unintended LC phenomena may be produced by parasitic and/or component inductors and capacitors, and may cause signal noise feedback at various, specific frequencies. These frequencies may be related to the specific component values and parasitics and/or the geometrical arrangement of the system. For example, an inductive element such as a bond wire might set up a resonant frequency with the component of the detector array filter.

Conventional methods for addressing such crosstalk and noise concerns include de-coupling the reference planes using component capacitors formed on a surface within the ROSA substrate. In order to de-couple a broad range of frequencies or many specific target frequencies, a large number of de-coupling capacitors may be required. Due to design constraints and the high integration levels, however, it may be difficult to provide the large number of component de-coupling capacitors on a surface of the ROSA substrate. Furthermore, conventional component de-coupling capacitors may include an undesirably high amount of effective series inductance (ESL) and effective series resistance (ESR) that produces a high Q and limits the range of frequencies that each component capacitor can de-couple.

It would therefore be desirable to provide a ROSA in which proper impedance matching and adequate bandwidth is maintained and cross-talk is eliminated between adjacent data channels in a tightly packed array.

### BRIEF SUMMARY OF THE INVENTION

According to one exemplary embodiment, the present invention provides an array of input pads for a transimpedance amplifier array. Each input pad is coupled to a corresponding photodetector. Disposed between each input pad of the TIA array is a ground pad.

According to another exemplary embodiment, the present invention provides a detector array with an electrically isolated metalized strip to provide an intermediary bonding point between the ground pads of the TIA array input and a ground reference plane.

According to another exemplary embodiment, the present invention provides an optoelectronic device including a ROSA that includes a transimpedance amplifier array and is formed within a multi-layer ceramic substrate. Coupled to the transimpedance amplifier array is a plurality of output data channels. Each output data channel extends along an exposed surface of a ceramic layer of the multi-layer ceramic substrate. The output data channels include data channels that are vertically spaced from the adjacent data channels and extend along different layers of the multi-layered ceramic carrier, which forms the ROSA.

According to another exemplary embodiment, the present invention provides a ROSA formed of a multi-layer ceramic substrate. The ROSA includes a plurality of data channels and a plurality of conductive reference planes formed between ceramic layers within the multi-layer ceramic substrate. The reference planes are de-coupled by embedded planar capacitors formed of the conductive planes themselves and utilizing the ceramic layers of the multi-layered ceramic carrier as the capacitor dielectrics.

According to another exemplary embodiment, the ground planes of the input and output grounds of an electronic component included in the multi-layered ceramic carrier, are separated on a ceramic layer in the vicinity of the electronic component and coupled together on another ceramic layer spaced further from the electronic component, via an inductor.

Other objects, features and advantages of the invention shall become apparent as the description thereof proceeds when considered in connection with the accompanying illustrative drawings.

### BRIEF DESCRIPTION OF THE DRAWINGS

In the drawings which illustrate the best mode presently contemplated for carrying out the present invention:

FIG. 1 is a plan view showing an exemplary receiver optical sub-assembly of the present invention showing the photodetector array and transimpedance amplifier array mounted on a multi-layer ceramic substrate;

FIG. 2 is an enlarged plan view of the photodetector array including the isolated metalized grounding strip;

FIG. 3 is a cross-sectional view thereof as taken along line 3-3 of FIG. 1;

FIG. 4 is a plan view showing a signal connection between the ROSA in FIG. 1 and a post-amplifier circuit on a PCB;

FIGS. 5-14 illustrate the various ceramic layers of the ceramic substrate which combine to provide the spaced data layers and the embedded planar capacitance; and

FIG. 15 is a plan view of one of the ceramic layers showing placement of an inductor between the ground planes.

### DETAILED DESCRIPTION OF THE INVENTION

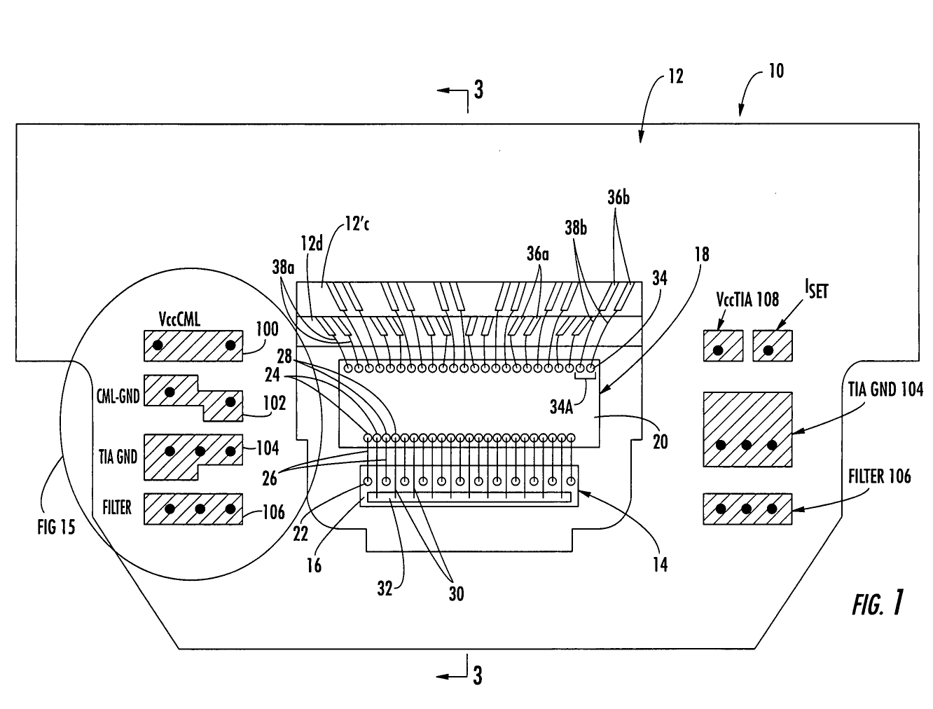

Referring now to the drawings, FIGS. 1-4 illustrate an exemplary embodiment of the present invention which provides a ROSA (receiver optical sub-assembly) 10 including a multi-layer ceramic substrate 12, a photodetector array 14 grown monolithically on a photodetector substrate 16, and a corresponding transimpedance amplifier (TIA) array 18 grown on a separate substrate 20, both of which are attached to the multilayer ceramic substrate 12.

The photodetector array 14 includes a plurality of photodetectors 22 which are coupled to input pads 24 of the TIA array 18 by conductive wire bonds 26. According to one exemplary embodiment, ground pads 28 may be formed between adjacent input pads 24 of the TIA array 18. Each of the ground pads 28 may be individually and directly coupled by a wire bond 30 to an isolated ground strip 32 formed opposite the photodetector array 14 and on the same photodetector substrate 16. The isolated strip 32 is then connected, via a number of wire bonds (not shown), to a ground reference plane (not shown) that sits adjacent to the photodetector substrate 16, opposite to the TIA array 18.

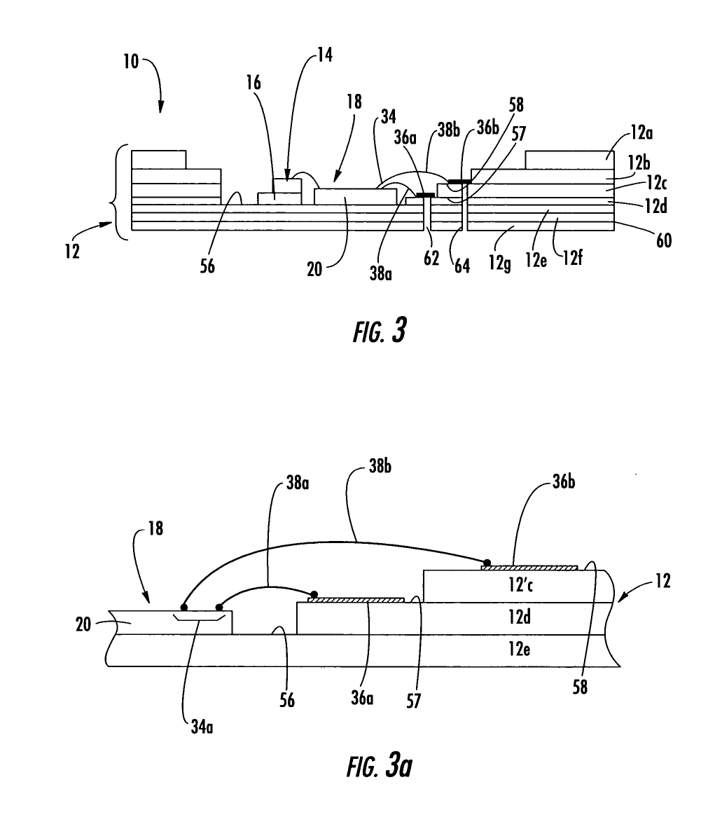

The TIA array 18 further includes output pads 34 for coupling the TIA array 18 to an external component that is not included within the ROSA 10. The output pads 34 are formed in a tightly-spaced arrangement, and in an exemplary embodiment as shown in FIG. 1, may consist of 12 pairs of differential outputs 34a formed in a linear array. Each pair 34a represents a single data channel. In an exemplary embodiment, the output pads 34 are formed at a 125 um pitch, or 250 um per channel, to match the pitch of the input pads 24. As will described in further detail hereinafter, the output pads 34 are electrically connected to signal lines 36a,36b, which are formed on the ceramic substrate 12, via wire bonds 38a,38b. The signal lines 36a,36b, or traces, on the ceramic substrate 12 are fanned out to a larger pitch that is advantageous in coupling the data signals to a post-amplifier or other external electronic component. Adjacent sets of differential pairs 34a, that is, adjacent data channels, extend along exposed surfaces of different ceramic layers 12c and 12d of the multi-layer ceramic substrate 12 in order to vertically separate the adjacent channels and alleviate crosstalk between them (See FIGS. 3 and 3a). Furthermore, the ceramic substrate 12 may be designed such that the signal lines 36a,36b are transmission lines in either a microstrip, stripline, coplanar, or other configuration. Therefore, the geometry of the signal lines 36a, 36b and their vertical distance from the reference plane within the ceramic 12 may be designed so as to precisely match the impedance of the system.

The multi-layer ceramic substrate 12 may also include embedded planar capacitors for de-coupling many of the multiple reference planes of the multi-layer ceramic substrate 12. An exemplary de-coupling ceramic capacitor may utilize the conductive reference plates as the capacitor electrodes, and an interposed ceramic layer of the multi-layer ceramic substrate 12, as the de-coupling capacitor dielectrics Respective input and output around planes for an electronic component such as a TIA 18, may be separated on a layer that is in relative close proximity to the transimpedance amplifier. The respective grounds may be coupled together on a ceramic layer that is further from the TIA 18, by means of an inductor. This allows de-coupling between the output and input stages of the TIA 18 while maintaining a level reference voltage.

More specifically, FIG. 1 is a plan view showing the ROSA 10 including transimpedance amplifier array 18 and photodetector array 14 mounted on the multi-layer ceramic substrate 12. TIA array 18 may include a substrate 20 that is mounted along with photodetector substrate 16 within the ROSA 10. According to other exemplary embodiments, TIA array 18 and photodetector substrate 16 may be disposed on other layers or in other configurations within other exemplary ROSAs 10. TIA array 18 includes an array of transimpedance amplifiers (not shown) and a corresponding array of input pads 24. Each TIA within the TIA array 18 is coupled to a respective input pad 24. In the exemplary embodiment, input pads 24 of TIA array 18 are arranged in a linear array of twelve input pads 24. Such is intended to be exemplary only, and according to other exemplary embodiments, various numbers of TIA input pads 24 may be used. Furthermore, according to other exemplary embodiments, the input pads 24 may be arranged in configurations other than the exemplary linear array. TIA array 18 also includes a plurality of output pads 34. In the exemplary embodiment, the twelve input pads 24 correspond to twelve data channels. In the exemplary embodiment shown in FIG. 1, TIA array 18 includes twenty-four output pads 34 arranged in a linear array.

According to the exemplary embodiment, each of the twelve data channels in the exemplary embodiment includes a differential signal pair output 34a from TIA array 18. Each data channel therefore utilizes two output pads 34a. Such is exemplary only, and according to other exemplary embodiments, each of the twelve data channels may include a single corresponding output pad 34. TIA array 18 is formed on a suitable substrate such as indium phosphide, gallium arsenide, or silicon, but other substrates may be used according to other exemplary embodiments.

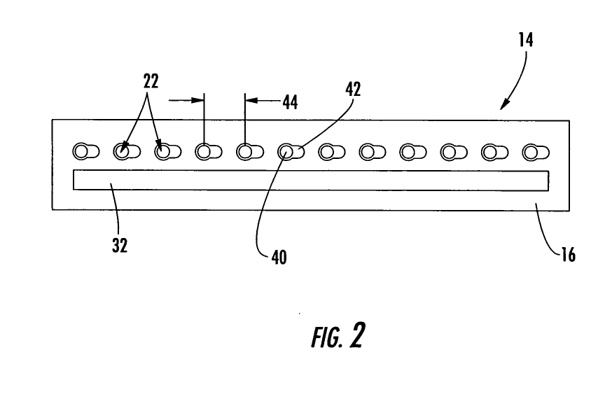

Photodetector substrate 16 includes a corresponding linear array of twelve photodetectors 22. Photodetectors 22 may be MSM photodetectors, P-I-N photodetectors, or other suitable photodetectors available in the art. FIG. 2 is an expanded plan view of photodetector substrate 16, also shown in FIG. 1. Referring now to FIGS. 1 and 2, photodetector substrate 16 may be formed of indium phosphide, gallium arsenide, silicon, or other suitable materials. In the exemplary embodiment shown, photodetector substrate 16 includes a corresponding plurality of twelve photodetectors 22 which correspond to the twelve input pads 24 of TIA array 18. As indicated above, each input pad 24 is coupled to a transimpedance amplifier of transimpedance amplifier array 18. Each photodetector 22 includes active area 40 for absorbing and detecting the optical signal and bond pad 42 to which a conductive medium may be bonded or otherwise coupled. In an exemplary embodiment, a conductive wire 26 is joined to each of bond pad 42 of photodetector 22 and a corresponding input pad 24 of TIA array 18, but other coupling techniques may be used in other exemplary embodiments to provide electrical coupling. In this manner, a data signal may be coupled from photodetector 22 to a corresponding TIA of TIA array 18, through corresponding input pad 24. The transimpedance amplifiers of TIA array 18 may thus be placed in close proximity to photodetectors 22, to reduce inductance, parasitics and the like, which may degrade the signal provided by photodetector 22. In an exemplary embodiment, pitch 44 between adjacent photodetectors 22 may be the industry standard of 250 micron pitch between data channels. According to this exemplary embodiment, the corresponding linear array of input pads 24 may also include a pitch of about 250 microns. Such is exemplary only, and according to other exemplary embodiments, the linear array of photodetectors 22 and input pad 24 may each include various other pitches. In this embodiment, the tightly-packed nature of the data channels, specifically the small spacing between adjacent wires 26 which form part of the data signal, may cause crosstalk between the channels, which degrades the signals sent from photodetector 22 to corresponding input pad 24 of TIA array 18. In an exemplary embodiment, the high-speed data signal from photodetector 22 to TIA array 18, by means of a corresponding input pad 24, may have a data rate of 2.5 gigabits per second. In other exemplary embodiments, the photodetectors 22 may receive optical signals having higher or lower data rates.

Ground pad 28 is formed between each adjacent set of input pads 24. This is exemplary only and in other exemplary embodiments, ground pads 28 may be disposed between some, but not all, of input pads 24. Each ground pad 28 is directly coupled to grounding strip 32 which is a metal trace formed on photodetector substrate 16 opposite the array of photodetectors 22. Various suitable materials may be used to form grounding strip 32. The generally rectangular shape of grounding strip 32 is exemplary only and various other configurations may be used in other exemplary embodiments. In the exemplary embodiment, conductive ground wires 30 are used to couple each ground pad 28 to grounding strip 32. According to one exemplary embodiment, conductive ground wires 30 may be wire-bonded to each ground pad 28 and grounding strip 32. Other arrangements for coupling each ground pad 28 to grounding strip 32 may be used in other exemplary embodiments. In the exemplary arrangement shown in FIG. 1, the linear array of input pads 24 and photodetectors 22 face each other such that each conductive wire 26 is a substantially linear member coupling photodetector 22 to the corresponding input pad 24. In this exemplary embodiment, the array of photodetectors 22 and input pads 24 have substantially the same pitch, but the respective pitches may vary in other exemplary embodiments. Conductive ground wires 30 are interdigitated between adjacent linear conductive wires 26. Grounding strip 32 is electrically isolated from photodetectors 22 and wire-bonded to a ground plane that is not shown. The interdigitation of conductive ground wires 30 between adjacent linear conductive wires 26 of the data signal may reduce parasitics due to mutual conductance which may otherwise result between adjacent wire bonds such as the wire bonds used for coupling conductive wires 26 to adjacent input pads 24 and adjacent photodetectors 22.

Each TIA of the TIA array 18 may include a data channel extending from its output pad 34 or pads 34a to an external component such as a post-amplifier integrated circuit (not shown). In an exemplary embodiment, the photodetector array 14 and TIA array 18 are placed in close proximity in the ROSA 10, while the post-amplifier is placed on another medium. In an exemplary embodiment, the post-amplifier integrated circuit may be formed placed on a printed circuit board such as the printed circuit board upon which the ROSA 10 is mounted. For high-speed signals, the distance that separates the transimpedance amplifiers from the post-amplifier may be significant, and it is therefore useful to maintain the integrity of the analog signal which travels along the data channel from the transimpedance amplifier to the post-amplifier. In order to maintain this integrity, the respective signal lines of the connective medium may be designed such that bandwidth and impedance matching between the transimpedance amplifier and post-amplifier is maintained. In this embodiment, the system is designed such that the signal lines 36 are microstrip transmission lines referenced to a plane on a buried layer of the ceramic substrate 12. The geometry of the signal lines 36, as well as the spacing between differential pairs 36a, 36b, is such that differential impedance is matched to that of both the TIA and the postamplifier. Other exemplary embodiments may use a stripling, coplanar, or other transmission line configuration. In this embodiment, the system uses differential pair signals to protect against common mode noise from nearby parasitic sources that may degrade the signal. Each data channel may include two output pads 34a to accommodate a differential signal pair. Each output pad 34 is thus dedicated to a conductive pathway for a differential signal of the differential pair 34a structure. According to other exemplary embodiments, each data channel may include a single output signal and therefore a single output pad 34 of the transimpedance amplifier array 18.

With the output data signal pads 34 of the TIA array 18 formed in such close proximity, especially when a differential pair structure 34a is used for each data channel, crosstalk between the output lines 36a,36b may degrade the signals output from the transimpedance amplifier array 18. According to one exemplary embodiment used in the industry, adjacent TIA output pads 34 may include a pitch of only 125 microns when a differential pair structure is used. According to other exemplary embodiments, different pitches may be used. The present invention provides for arranging the output lines 36a, 36b from the TIA array 18 such that proper differential impedance and bandwidth is maintained for each channel, and crosstalk between channels is minimized or eliminated, regardless of the pitch used. This is true when the output from the TIA array 18 utilizes a differential pair structure or other data channel configuration. The present invention fans out the conductive signal lines 36a, 36b on the ceramic substrate 12 to a larger pitch which may be more easily interconnected to an external component such as a post-amplifier. Although shown and described in conjunction with data channels extending from a TIA array 18 to a post-amplifier, such is intended to be exemplary only and the principles described herein may also be applied to other output signals used in conjunction with various optoelectronic devices.

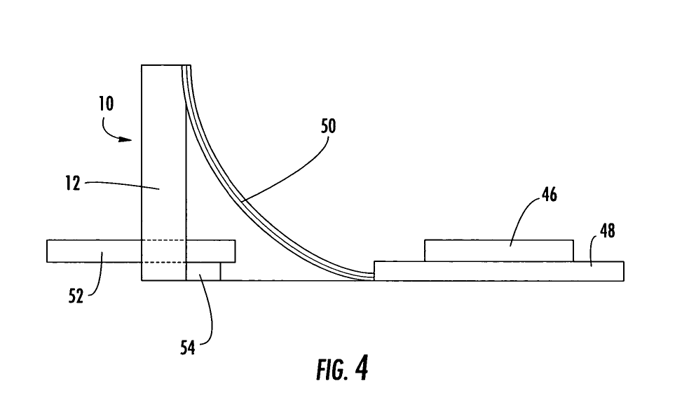

Referring now to FIG. 4, there is shown a schematic illustration of an exemplary signal connection between a ROSA 10 and a post-amplifier circuit generally indicated at 46. Referring to the schematic of FIG. 4, multi-layer ceramic substrate 12 may include circuitry and various components therein to form a ROSA 10. Multi-layer ceramic substrate 12 may be formed of a plurality of individual ceramic layers 12a-12k and may include components included within an aperture formed through at least some of the ceramic layers. The components may include a transimpedance amplifier array 18, a photodetector array 14, and various other associated components. Multi-layer ceramic substrate 12 may be formed of materials and according to the methods shown and described in U.S. application Ser. No. 09/969,085, entitled High Speed Optical Subassembly with Ceramic Carrier and filed on Oct. 1, 2001, the contents of which are herein incorporated by reference. FIG. 4 is a schematic including a representation of multi-layer ceramic substrate 12 coupled to printed circuit board 48. A flex circuit 50 may be used to couple electrical data signals of the multiple channels, as well as power and ground signals, between the ROSA 10 formed on ceramic substrate 12 and post-amplifier integrated circuit 46 formed on printed circuit board 48. The integrated circuit including a post-amplifier circuit 46 with multiple inputs and outputs may be mounted on the printed circuit board 48 using conventional methods. According to other exemplary embodiments, connecting media other than flex circuit 50 may be used to couple the electrical signals from multi-layer ceramic substrate 12 to components formed on printed circuit board 48 such as exemplary post-amplifier 46.

FIG. 4 further shows an exemplary arrangement in which multi-layer ceramic substrate 12 is positioned using guide pins 52 of a guide pin plate 54. Other arrangements for mounting multi-layer ceramic substrate 12 to printed circuit board 48 may be used alternatively. Furthermore, other techniques for coupling electrical data channels from multi-layer ceramic substrate 12 to printed circuit board 48 may be used according to other exemplary embodiments.

Referring back to FIGS. 3 and 3a, cross-sectional views are provided showing portion of the multi-layer ceramic substrate 12. Multi-layer ceramic substrate 12 includes exemplary ceramic layers 12a-j. Ceramic layer 12a is formed over portions of ceramic layer 12c which, in turn, is formed over portions of ceramic layer 12d, etc. to form a step-like structure, including exposed surfaces 56, 58, 58 along which data channels may be formed. Transimpedance amplifier array 18 is mounted on the surface 56 of ceramic layer 12d in the exemplary embodiment. Conductive wire-bond 38a couples an output 34 of transimpedance amplifier array 18 to conductive trace 36a formed on exposed surface 57 of ceramic layer 12d. Each conductive trace/wire combination may represent a data channel. Transimpedance amplifier array 18 also includes conductive wire 38b, which couples an adjacent output 34 of transimpedance amplifier array 18 by means of wire bond 38b, to conductive trace 36b formed on exposed surface 58 of ceramic layer 12c. Conductive traces 36a and 36b are vertically spaced from one another, as they are formed on two different ceramic layers 12c and 12d, respectively. This is intended to be exemplary only, and the output signals of transimpedance amplifier 18 may be coupled to conductive traces formed on three or more of the ceramic layers 12a-j, which combine to form the multi-layer ceramic carrier 12. The vertical spacing is determined by the thickness of the ceramic layers 12a-j which may be 228 um in one embodiment. This is exemplary only and various other step heights, i.e., vertical spacing, may be used in other exemplary embodiments. The data channels including conductive traces 36a and 36b may be coupled to various external components, such as a post amplifier.

Adjacent channels 34a, each including a differential signal pair 36a, 36b, are spaced vertically from each other in multi-layer ceramic carrier 12. Adjacent channels or adjacent sets of differential signal pairs 36a, 36b are therefore formed to extend along different layers of multi-layer ceramic substrate 12, which are spaced vertically from each other. The vertical spacing decreases crosstalk between adjacent pairs of signals 36a, 36b, which may be high-speed signals such as 2.5 Gbps or higher. Each data channel extends along an exposed surface of a ceramic layer, such as exposed surface 57 of ceramic layer 12d and exposed surface 58 of ceramic layer 12c. For example, the data channel shown on the extreme right-hand side in FIG. 1 includes two conductive traces 36b formed on ceramic layer 12c. Each conductive trace 36b is wire bonded to a corresponding output pad 34 by means of longer conductive wire 38b. In contrast, the data channel or differential signal pair 36a formed on the extreme left-hand side, includes two conductive traces 36a which are formed on a different vertical level, ceramic layer 12c. Each of the conductive traces 36a are coupled to a corresponding output pad 34 by shorter conductive wire 38a which is wire bonded to conductive trace 36a. As such, in the exemplary arrangement shown in FIG. 1, six pairs of differential signals are coupled to conductive traces 36b formed on ceramic layer 12c, and six pairs of differential signals are coupled to conductive traces 36a formed on ceramic layer 12d. Adjacent data channels are therefore vertically spaced from each other and extend along different layers of multi-layer ceramic substrate 12. This is exemplary only and, in other embodiments, some data channels may be formed along one ceramic layer and other data channels along another ceramic layer or layers, but the data channels may not be arranged such that each adjacent set of channels are formed on different ceramic layers. According to still other exemplary embodiments, more than two layers of multi-layer ceramic carrier 12 may include conductive traces of the data channels formed thereon. Conductive traces 36a and 36b may include the same line width or their respective line widths may differ.

Referring back to FIGS. 3 and 3a, a cross-sectional view showing exemplary multi-layer ceramic substrate 12 is provided. In addition to ceramic layers 12c, 12d and 12e previously discussed, multi-layer ceramic substrate 12 also includes ceramic layers 12a, 12b, 12f and 12g. The positioning of the data channels such as shown in FIG. 1 and the thicknesses of the ceramic layers and therefore the vertical spacing between the data channels formed on different levels are chosen to maintain the proscribed differential impedance and bandwidth. In the exemplary embodiment shown, an exemplary reference plane may be formed along interface 60 formed between ceramic layers 12f and 12g. Conductive traces 36b formed on ceramic layer 12c are therefore spaced a greater distance from the reference plane 60 than are conductive traces 36a formed on ceramic layer 12d. The positioning of reference plane along interface 60 is exemplary only, and the reference plane 60 may be positioned at various other locations within multi-layer ceramic substrate 12, in other exemplary embodiments. A fundamental concept of this exemplary embodiment is that the trace widths of conductive traces 36a and 36b, and the separation distance between channels that are higher in the vertical stack, may differ from those that are lower in the vertical stack, in order to maintain the same differential impedance and bandwidth although the distance from the reference plane formed along interface 60, is greater for channels spaced further away, such as a channel including conductive trace 36b formed on ceramic layer 12c, in comparison to a channel including conductive trace 36a formed on ceramic layer 12d.

Each of the conductive traces 36a and 36b may be coupled to a post-amplifier integrated circuit or other external components through various means. In one exemplary embodiment, a flex circuit 50 may be used. In one exemplary embodiment, conductive traces 136 and 138 may be electrically coupled to a further component by means of a conductive via formed to extend through multi-layer ceramic substrate 12. According to one exemplary embodiment, conductive traces 36a and 36b may be electrically coupled to bottom surface 12g of multi-layer ceramic substrate 12 by means of respective conductive vias 62 and 64. Each of conductive vias 62 and 64 may terminate in a conductive pad formed on bottom surface 12g. Conductive traces 36a and 36b, and therefore the respective data channels, may be electrically coupled to an external component which is coupled to conductive vias 62 and 64, respectively, which terminate on bottom surface 12g.

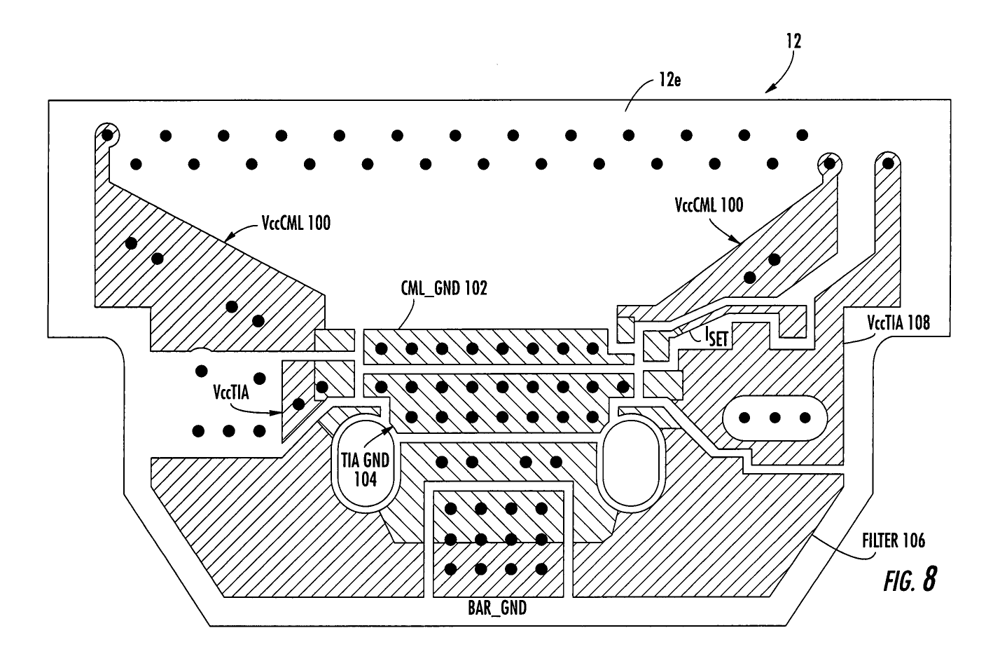

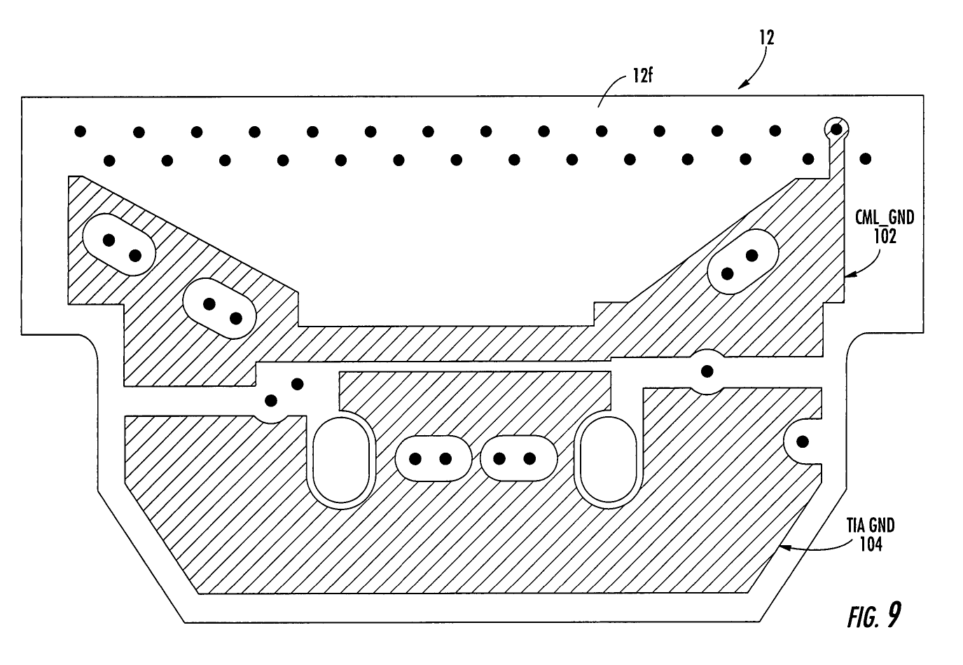

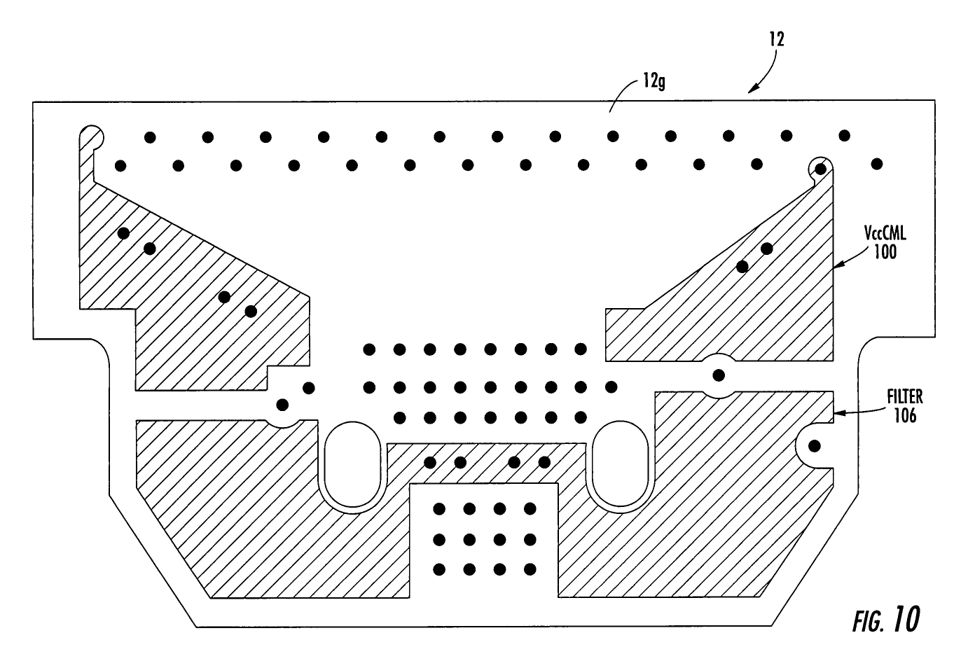

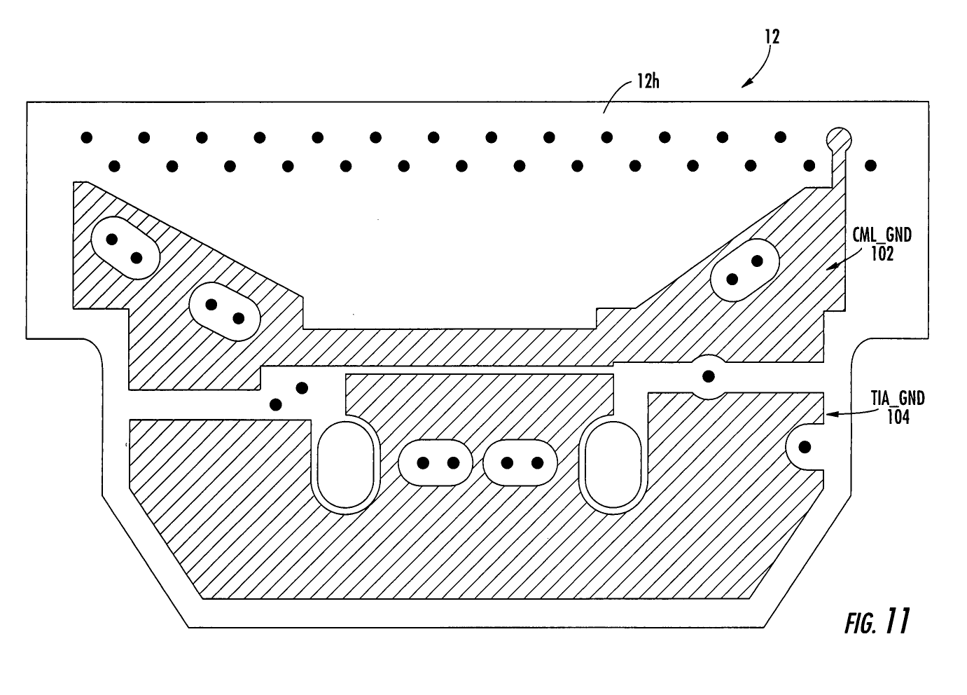

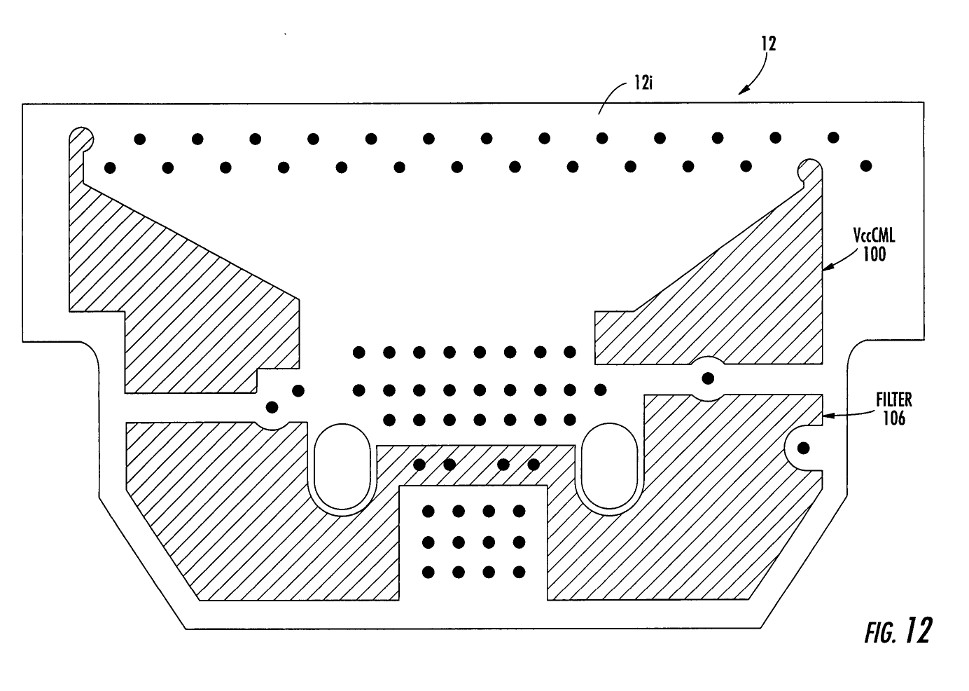

FIGS. 8-14 illustrate different layers of ceramic used to provide planar capacitance to alleviate crosstalk and parasitic noise at problem frequencies in a ROSA 10 in an embodiment according to the present invention. The problem frequencies may include what are considered both high and low frequencies. The frequencies and sources of the crosstalk can be ascertained experimentally. The widely accepted solution to broadband noise is to use a capacitor ladder, or a series of many capacitors of different values that cover the spectrum of the noise frequencies. However, in the design of small, high compact, parallel transceivers, there are two problems with this approach. First, there is no room on the ROSA 10 for even one or two more elements, let alone a capacitive ladder. Using the ceramic layers 12a-12k themselves to form the capacitive elements requires no additional space. Second, physical capacitors of any kind will introduce a certain amount of effective series inductance (ESL) and resistance (ESR) into the system. These elements limit the effective bandwidth of the capacitors and may introduce more noise by setting up and LC or RLC resonance in the circuit. A better solution is to use the multiple ceramic layers 12a-12k themselves as ‘planar’ capacitors. This methodology has the desirable attribute of introducing no ESL or ESR into the system. The difficulty of this methodology is to design the capacitors to the required frequencies. This is dependent on the geometry and area of the metalized regions of the different areas, as well as the number and thickness of the dielectric layers.

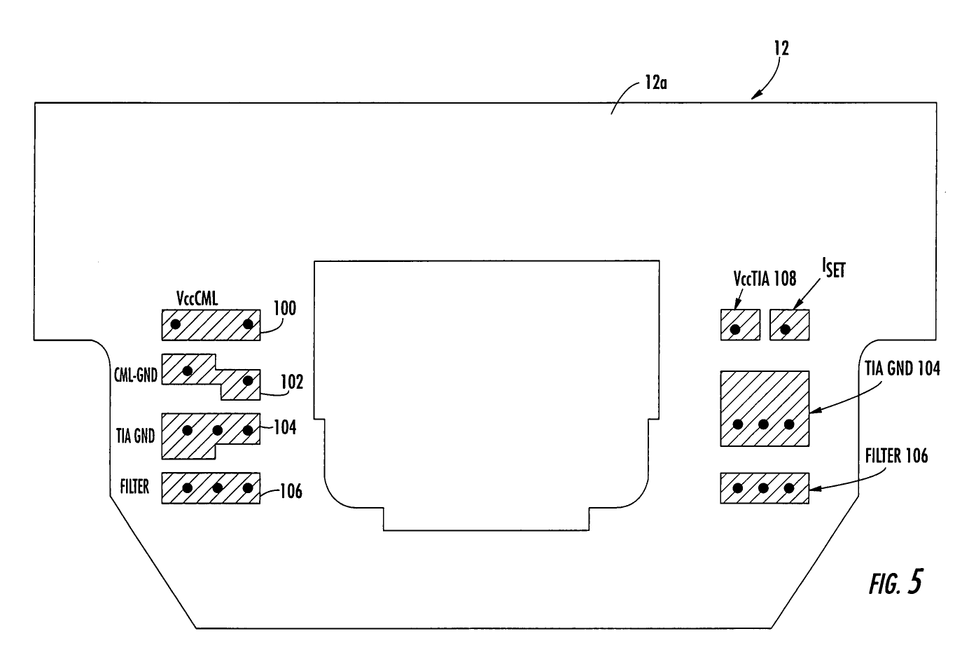

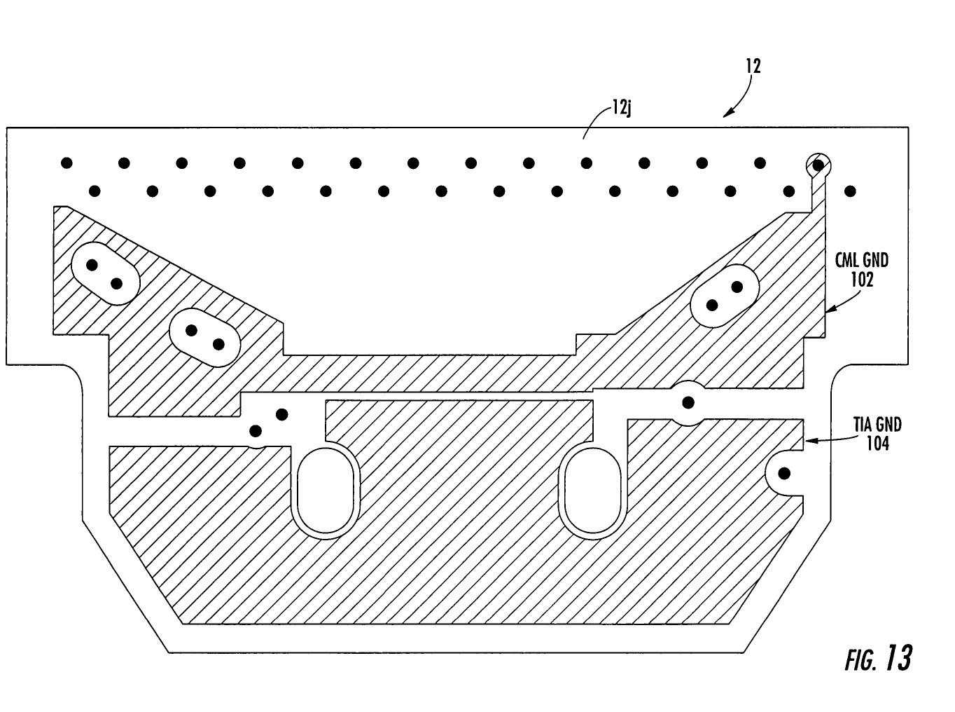

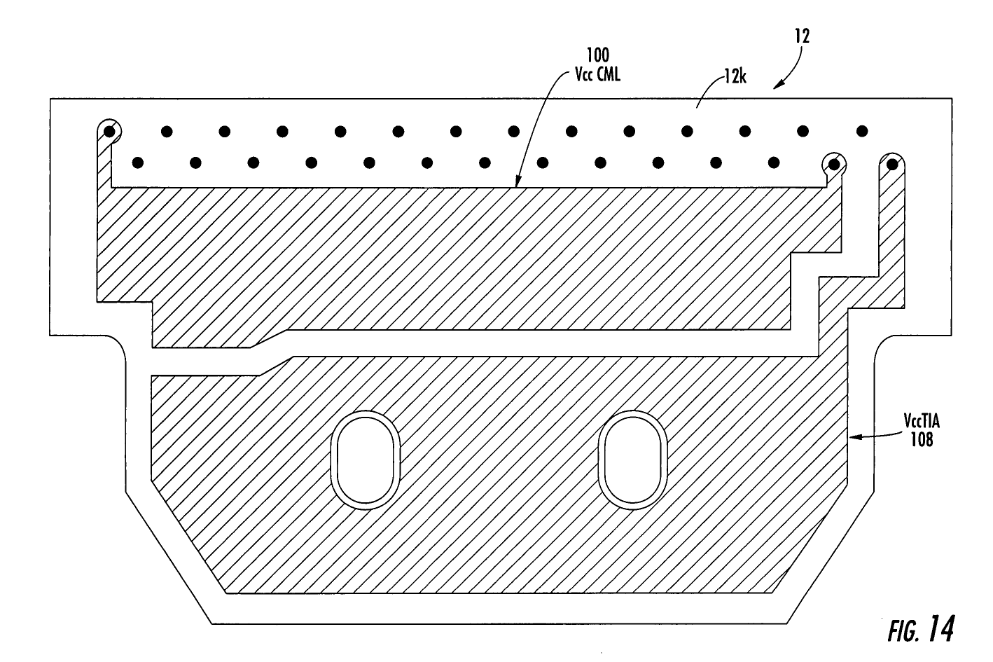

In the present, exemplary invention, the ceramic 12 has a total of 11 layers 12a-12k. Seven of these layers 12e-12k are used in the design of the planar capacitors. The primary objects of the filtering are the VccCML 100, which is the reference plane, the two ground planes (CMLGnd 102 and TIAGnd 104), and the Filter plane 106. Referring to the top region of the ROSA 10 in FIG. 5, and looking down through the layers sequentially through FIG. 14, it will be noticed that the VccCML 100 and CMLGnd 102 planes alternate. This forms an effective broadband filter capacitor from VccCML 100 to CMLGnd 102. In like manner, referring to the bottom region of the ROSA 10 in FIG. 5 and looking down through the layers sequentially to FIG. 13 it will be noticed that the Filter 106 and TIAGnd 104 planes alternate. This also forms an effective broadband filter capacitor from Filter 106 to TIAGnd 104.

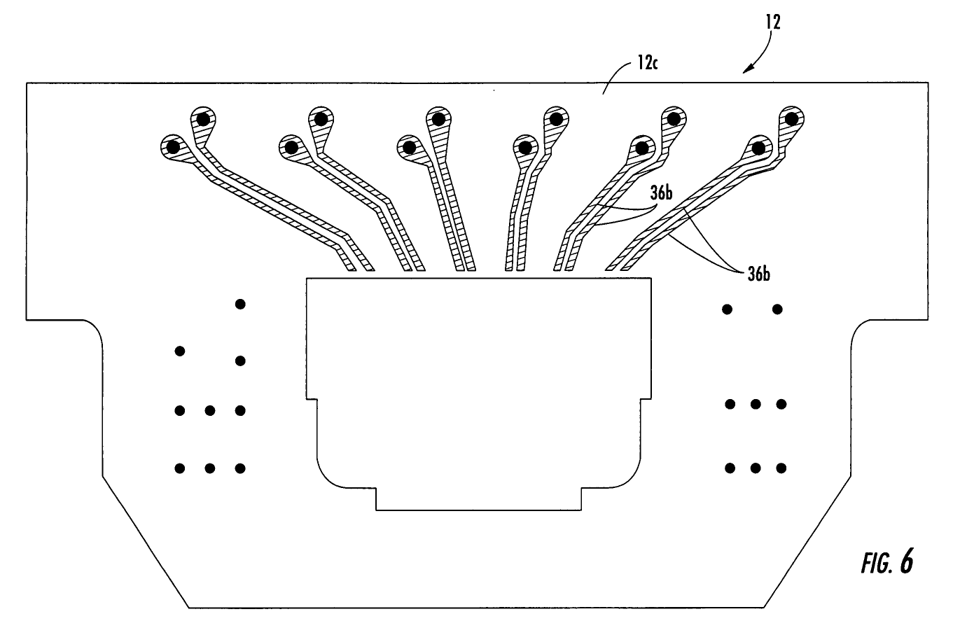

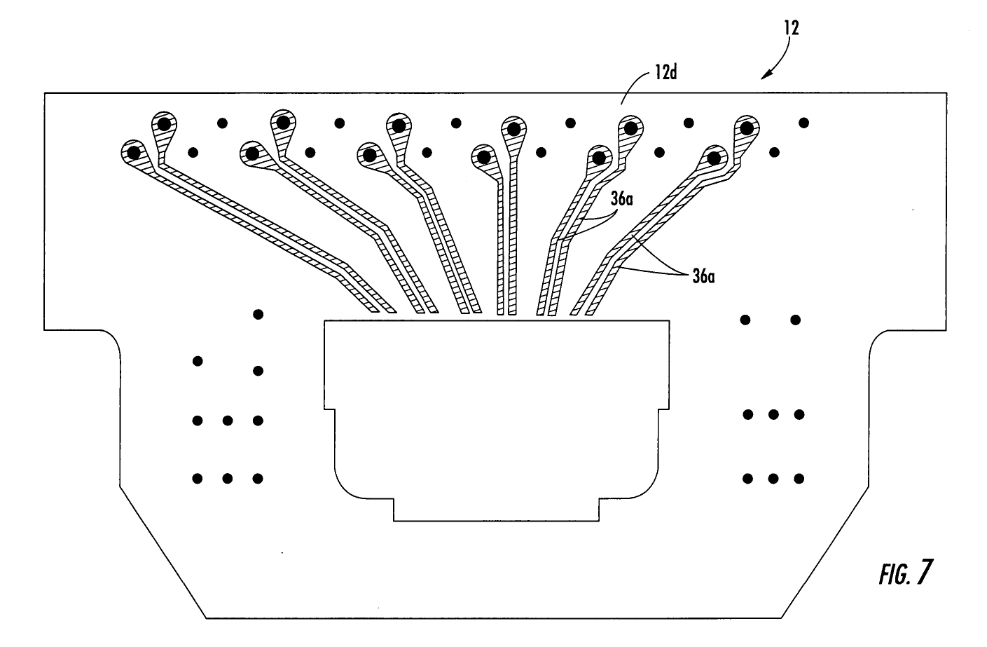

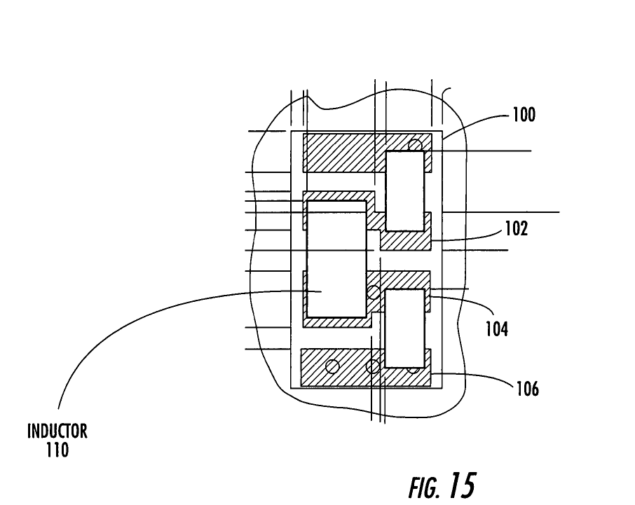

It should also be noted that nowhere in FIGS. 5-14 are the two ground planes, CMLGnd 102 and TIAGnd 104, connected. This is to insure that there is not crosstalk between the output stages of the TIA 14 and the Input stages of the TIA 14 through a common ground. However, it is important to the stability and functionality of the TIA 14 that the two grounds are at the same electrical reference. Therefore, referring to FIG. 15, the grounds are connected be means of an inductor 110 placed between the CMLGnd pad, item 102, and the TIAGnd pad, item 104. The inductor 110 allows DC conduction between the two planes but blocks all high frequency elements. This is more particularly illustrated in FIG. 15. This refers to a portion of the ceramic layer in FIG. 1, as discussed above. In this diagram, the inductor 110 is shown placed across pads 102 and 104.

It can therefore be seen that the present invention provides for a highly compact ROSA 10 array that densely concentrates several channels of data while including capacitance arrays that virtually eliminate cross-talk, impedance loss and parasitics. For these reasons, the instant invention is believed to represent a significant advancement in the art which has substantial commercial merit.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

1. An optoelectronic device comprising:
an array of photodetectors;
an array of input pads for a transimpedance amplifier array, each input pad coupled to a corresponding photodetector; and
a ground pad disposed between at least one adjacent set of said input pads.

2. The optoelectronic device of claim 1, wherein each of said input pads is coupled to said corresponding photodetector by a conductive wire, said wire bonded to each of said photodetectors and said corresponding input pads.

3. The optoelectronic device of claim 1, wherein each of said corresponding photodetectors is included in a corresponding array of photodetectors, and one of said ground pads is disposed between each adjacent set of said input pads.

4. The optoelectronic device of claim 3, wherein each of said array of input pads and said transimpedance amplifier array is formed on a first substrate, said array of photodetectors is formed on a second substrate, and each said input pad is coupled to said corresponding photodetector by means of a conductive wire bonded to each of said input pad, and a bond pad of said corresponding photodetector.

5. The optoelectronic device of claim 4, further comprising:
a ground structure formed on said second substrate, said ground structure connected to ground and to each of said ground pads.

6. The optoelectronic device of claim 3, wherein said array of input pads includes a linear array and said corresponding array of photodetectors includes a linear array, each photodetector including a bond pad, and wherein each of said input pads is coupled to said bond pad of said corresponding photodetector, by means of a substantially linear conductive lead.

7. The optoelectronic device of claim 6, wherein each of said linear array of input pads and said corresponding linear array of photodetectors, includes substantially the same pitch.

8. The optoelectronic device of claim 6, further comprising:
a ground strip connected to ground, said array of photodetectors situated between said ground strip and said array of input pads, wherein each ground pad includes a conductive ground lead extending therefrom and coupled to said ground strip, said conductive ground leads interposed between adjacent ones of said substantially linear conductive leads.

9. The optoelectronic device of claim 1, further comprising:
a ground structure connected to ground and to each of said ground pads.

10. The optoelectronic device of claim 9, wherein each of said ground pads is connected to said ground structure by a wire bonded to each of said ground pad and said ground strip.

11. The optoelectronic device of claim 3, wherein said array of input pads and said transimpedance amplifier array are formed on a first substrate and said array of photodetectors is formed on a second substrate, each of said first substrate and said second substrate included within a multi-layer ceramic substrate.

12. The optoelectronic device of claim 1, wherein said optoelectronic product is a ROSA (receiver optical subassembly) and each input pad and corresponding photodetector form part of a data channel.

13. A ROSA (receiver optical subassembly) comprising:
a plurality of photodetectors;
a plurality of data channels, each data channel including a conductive lead coupling an input pad of a transimpedance amplifier to a corresponding photodetector; and
a ground pad disposed between each adjacent set of said input pads.

14. The ROSA of claim 13, wherein said input pads and said ground pads are each formed on a first substrate and said corresponding photodetectors are formed on a second substrate disposed within said ROSA, and each input pad is wire bonded to a bond pad of said corresponding photodetector.

15. The ROSA of claim 14, wherein said ground pads are each coupled to a ground structure formed on said second substrate, and said corresponding photodetectors are situated between said input pads and said ground structure.

16. An optoelectronic device comprising:
a plurality of data channels in a multi-layer ceramic substrate of a ROSA (receiver optical sub-assembly), each data channel extending along an exposed surface of a ceramic layer of said multi-layer ceramic substrate and coupled to a transimpedance amplifier included within said multi-layer ceramic substrate, said plurality of data channels including data channels extending along different ceramic layers of said multi-layer ceramic substrate.

17. The optoelectronic device of claim 16, wherein at least one of said data channels is vertically spaced from other of said data channels.

18. The optoelectronic device of claim 16, wherein each data channel includes a differential signal pair, each differential signal including a conductive trace formed on said exposed surface and coupled to a corresponding output pad of said transimpedance amplifier.

19. The optoelectronic device of claim 18, wherein each differential signal includes said conductive trace wire-bonded to said corresponding output pad of said transimpedance amplifier.

20. The optoelectronic device of claim 16, wherein adjacent data channels of said plurality of data channels extend along different layers of said multilayer ceramic substrate.

21. The optoelectronic device of claim 20, wherein alternate data channels extend along an upper ceramic layer of said multi-layer ceramic substrate, and other data channels extend along a lower ceramic layer of said multi-layer ceramic substrate.

22. The optoelectronic device of claim 21, wherein said upper ceramic layer is formed directly on a portion of said lower ceramic layer, said upper ceramic layer thereby forming a step over said lower ceramic layer.

23. The optoelectronic device of claim 16, wherein a plurality of said ceramic layers of said multi-layer ceramic carrier, are stacked such that each of said plurality of said ceramic layers includes an exposed surface.

24. The optoelectronic device of claim 16, wherein each data channel includes a conductive trace that extends along said exposed surface of said ceramic layer of said multi-layer ceramic substrate and is coupled to an output pad of said transimpedance amplifier, said output pads formed in a linear array having a first pitch and said conductive traces extending from said output pads to include a second pitch being greater than said first pitch.

25. The optoelectronic device of claim 18, wherein said output pads are formed in a linear array and include a first pitch, and said conductive traces extend from said output pads to include a second pitch being greater than said first pitch.

26. The optoelectronic device of claim 25, wherein each of said conductive traces are further coupled to a post-amplifier through a conductive via formed through said multi-layer ceramic substrate.

27. The optoelectronic device of claim 16, wherein said multi-layer ceramic substrate includes at least three ceramic layers along which said data channels extend.

28. The optoelectronic device of claim 16, wherein said data channels extend along a first ceramic layer and a second ceramic layer, and further comprising a ground plane formed between further ceramic layers of said multi-layer ceramic substrate.

29. The optoelectronic device of claim 28, wherein a first data channel includes a first conductive trace that extends along said first ceramic layer and a second data channel includes a second conductive trace that extends along said second ceramic layer, said first conductive trace including a first width and said second conductive trace including a second width, said first width differing from said second width such that said first conductive trace and said second conductive trace include substantially the same differential impedance and bandwidth.

30. The optoelectronic device of claim 19, wherein adjacent data channels of said plurality of data channels extend along different ceramic layers of said multi-layer ceramic substrate.

31. The optoelectronic device of claim 16, wherein said data channels are spaced apart by a first distance at a first location at which said data channels are coupled to said transimpedance amplifier and spaced apart by a second distance at a second location, said second distance being greater than said first distance.

32. An optoelectronic device comprising:
a ROSA (receiver optical subassembly) including a plurality of data channels, each data channel including a differential pair of conductive signal lines coupling a transimpedance amplifier included within said ROSA, to a post-amplifier integrated circuit, said conductive signal lines each including a conductive trace that extends from said transimpedance amplifier along a multi-layer ceramic substrate, adjacent conductive trace extending along exposed surfaces of different layers of said multi-layer ceramic substrate.

33. An optoelectronic device comprising:
a ROSA (receiver optical subassembly) including a transimpedance amplifier array including a corresponding array of differential signal pairs coupled thereto, each said differential pair forming a data channel for being coupled to a post-amplifier, adjacent data channels extending along different layers of a multi-layer ceramic substrate.
